(19) United States
(12) Patent Application Publication
(10) Pub. No.: US 2010/0300498 A1
(43) Pub. Date: Dec. 2, 2010

(54) EASY CHANGE TUBE CLEANING SYSTEM

(76) Inventors: Donald Anthony Wojciechowski, III, Redford, MI (US); Matthew O. Herhold, Fenton, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/475,912

(22) Filed: Jun. 1, 2009

(51) Int. Cl. B08B 9/04; B08B 9/02

(52) U.S. Cl. 134/167 C

(57) ABSTRACT

A tube cleaning system for cleaning tubes such as heat exchanger tubes is capable of driving a variety of diameters of lances. A notch in the drive belts is capable of driving the several diameters. In addition, a clamp biases belt guides against the guides to hold the guides against the lances. Further, a housing for housing the drive mechanism can be pivoted to an open position to facilitate changeover of the lances.

### BACKGROUND OF THE INVENTION

This application relates to a lance tube cleaning system, wherein a drive assembly for the lances facilitate changeover of the lances.

Lances are utilized to clean tubes, such as may be found in heat exchangers. A lance is attached to a spray head, and a drive mechanism drives a plurality of lances into the tubes. The spray head then sprays high pressure water in the tubes.

This type of cleaning system has enjoyed wide success, and is widely utilized in industry. However, the changeover of the lance cleaning systems to different sizes of lances has required undue assembly time. Generally, different drive members are required for different diameter of lances. Different diameters of lances are required for different diameters of tubes, as an example. In generally, complete disassembly and reassembly is required.

### SUMMARY OF THE INVENTION

A lance cleaning system includes at least one lance connected to a source of high pressure fluid, and to a nozzle. A drive mechanism drives the lance. The drive mechanism includes at least one drive gear for engaging a belt. The belt engages an outer periphery of the lance, and drives the lance. The belt has a groove which is in contact with the lance. The groove has a configuration such that the belt can drive a plurality of diameters of lances.

In other features, a lance cleaning system includes at least one lance connected to a source of high pressure fluid, and to a nozzle. A drive mechanism drives the lance. A housing for the drive mechanism includes two housing portions. A latch secures the housing portions together. A hinge attaches the housing portions, such that the housing portions can pivot away from each other to provide access for changeover of the lances.

In another feature, a lance cleaning system has at least one lance connected to a source of high pressure fluid, and to a nozzle. A drive mechanism drives the lance, and includes at least one drive gear for engaging a belt. The belt engages an outer periphery of the lance and drives the lance. Clamps bias the drive belt against the lances.

These and other features of the present invention can be best understood from the following specification and drawings, the following of which is a brief description.

### BRIEF DESCRIPTION OF THE DRAWINGS

FIG. 1 schematically shows an application of the lance cleaning system.

FIG. 2 is a cross-sectional view through a drive mechanism.

FIG. 3 is an enlarged view of an alternative arrangement.

FIG. 4 is a cross-sectional view in a perpendicular plane of FIG. 2.

FIG. 5 shows a clamp assembly.

FIG. 6 shows the clamp assembly.

### DETAILED DESCRIPTION OF THE PREFERRED EMBODIMENT

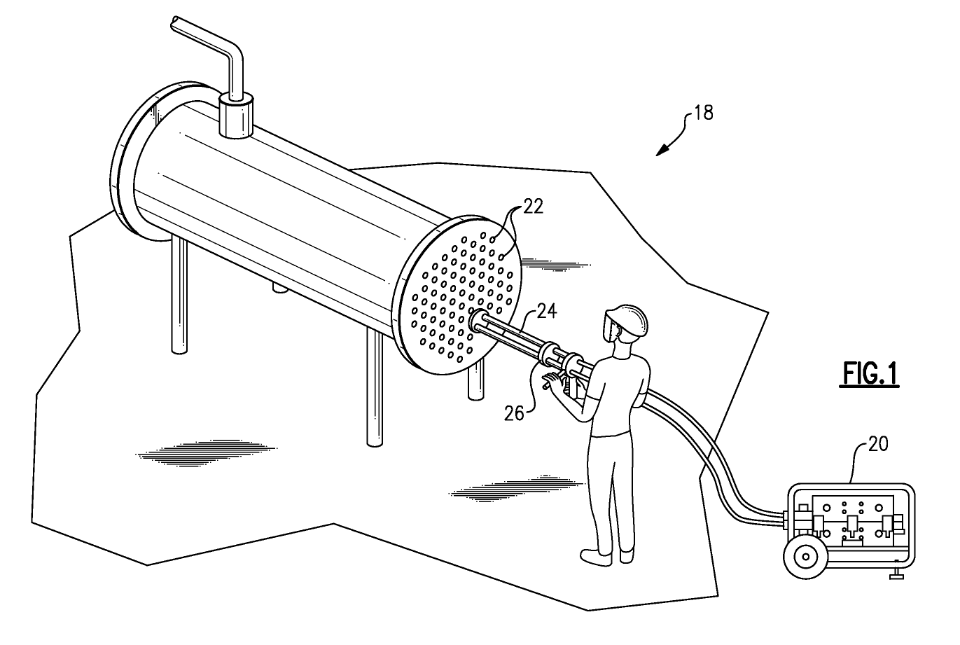

FIG. 1 shows a cleaning system 18 schematically. A drive mechanism 20 drives a plurality of lances 24 into tubes 22 for cleaning. A cleaning nozzle is attached to an end of the lances which is received within the tubes, as known. A mechanism 26 is held by an operator and a drive mechanism 20 drives the lances into the tubes 22. While the lances are shown as flexible, the invention also extends to rigid lance drives. If flexible lances are used, they may be stored on a reel or simply arranged behind the drive. High pressure water jets into the tubes for cleaning. This basic arrangement is as known.

FIG. 2 is a cross-sectional view through the inventive drive mechanism 20. As shown, the lances 24 are contacted by belts 30. The belts 30 have generally triangular grooves 34 which contact outer peripheries of the lances 24. The drive mechanism 20 is shown to have two housing parts 97 and 98. Element 97 is generally placed on a wheeled platform (see FIG. 1). As an alternative to the platform shown in FIG. 1, the platform may also include guides for moving the lances horizontally and vertically. Element 98 is vertically above element 97. A latch 100 latches onto a latch portion 101 on housing 98. The housing elements 97 and 98 are connected by hinges 102. To open the drive mechanism 21, one merely actuates the latch 100 to release the latch from the portion 101. Then, the housing element 98 can be pivoted upwardly away from the element 97. An upper belt portion 30 is moved away from a lower portion of the belt 30. At this point, the lances 24 can be easily removed for changeover.

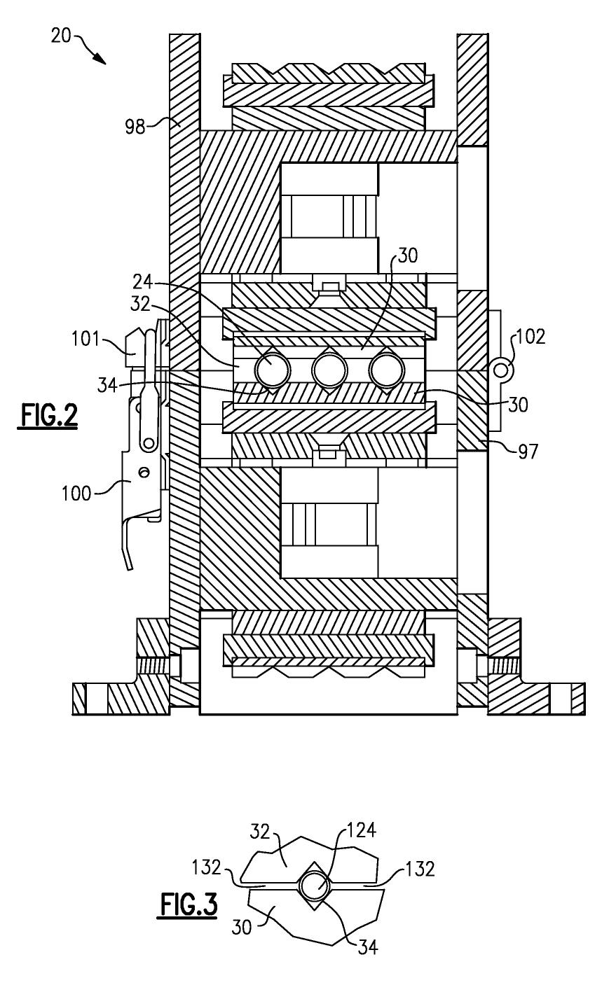

As can be appreciated from FIG. 3, a smaller diameter lance 124 will be in contact with the triangular grooves 34. As can be appreciated in FIGS. 2 and 3, the space 32 between the belts with the larger diameter tube 24 is greater than the space 132 with the smaller diameter belts 124 of FIG. 3. A clamp mechanism, described below, ensures the belts are still biased firmly into contact with the lances 24/124.

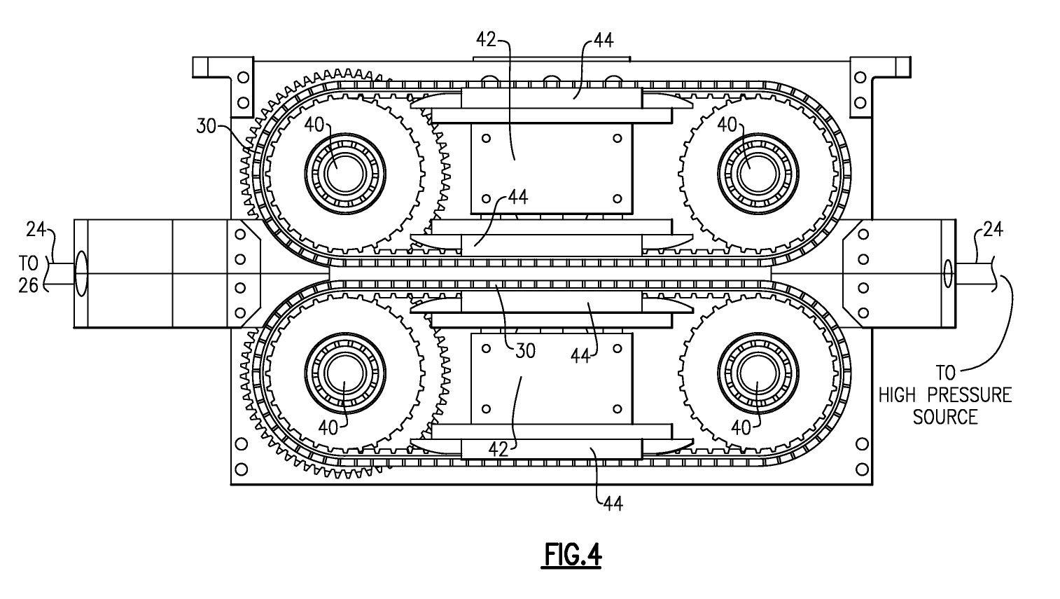

FIG. 4 is a cross-sectional view through the drive mechanism 30 generally alone a plane perpendicular to plane in FIG. 2. As can be appreciated, the lances 24 come from a connection to a high pressure water source, and to the right of FIG. 4. The drive mechanism drives the lances to the element 26, and to the left of FIG. 4. Gears 40 include at least one gear on each of the upper and lower belts 30 which is a drive gear. As can be appreciated, the belts are driven to move, engage and drive the lances 24.

Clamps 42 clamp slider belt guides 44 upwardly against the belts 30, to hold the belts in tension against the lances 24.

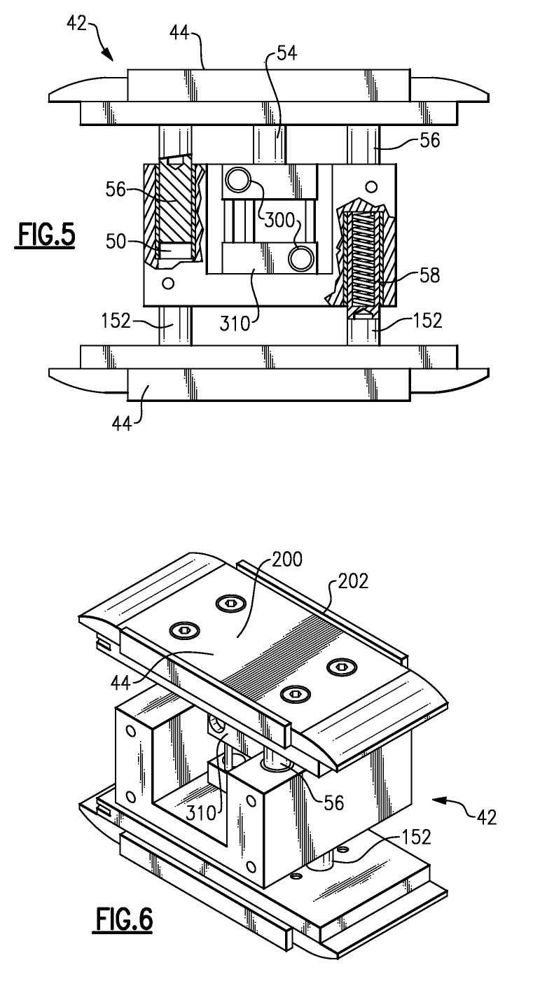

As can be appreciated from FIG. 5 and 6, the belt guides 44 have a generally flat surface 200 which engages the belts, and sidewalls 202 which capture and guide the belts.

As can be appreciated from FIGS. 5 and 6, a guide chamber 50 receives guide rods 56. There may be four guide rods 56, with one at each corner. A pneumatic cylinder 310 has a rod 54 fixed to the upper belt guide 44. Air is injected into openings 300 to drive the components of the pneumatic cylinder away from each other, and force the upper belt guide 44 upwardly as shown in FIG. 5. This ensures the belt guides are biased against the belts, and the belts are thus biased against the lances.

In addition, there are two spring biased rods 152. The spring biased rods have springs 58 biasing the two components away from each other.

The clamps 42 assist in ensuring that the belts 30 will be held in close relationship to the lances, even when the diameter of the flexible lances is changed.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A lance cleaning system comprising:
at least one lance for being connected to a source of high pressure fluid, and to a nozzle;
a drive mechanism for driving said lance, said drive mechanism including at least one drive gear for engaging a belt, said belt engaging an outer periphery of said lance, and driving said lance; and
said belt having a groove which is in contact with said lance, and said groove having a configuration such that said drive belt can drive a plurality of diameters of said lance.

2. The system as set forth in claim 1, wherein said groove is generally triangular.

3. The system as set forth in claim 2, wherein an upper belt and a lower belt are both provided with said generally triangular grooves to engage both sides of said flexible lance.

4. The system as set forth in claim 3, wherein a clamp biases belt guides against said upper and lower belts, and holds said upper and lower belts against said lance.

5. The system as set forth in claim 4, wherein said clamp includes a pneumatic clamp.

6. The system as set forth in claim 5, wherein a spring tensioner is also utilized with said pneumatic clamp.

7. The system as set forth in claim 4, wherein a spring biases said tensioner into engagement with said belt.

8. The system as set forth in claim 1, wherein a housing for housing said drive mechanism includes two housing portions, and there being a latch to secure said housing portions together, and a hinge attaching said housing portions, such that said housing portions can pivot away from each other to provide access for changeover of said lances.

9. The system as set forth in claim 8, wherein said groove is generally triangular.

10. The system as set forth in claim 9, wherein an upper belt and a lower belt are both provided with said generally triangular grooves to engage both sides of said lance.

11. The system as set forth in claim 1, wherein said clamps bias belt guides against said belts.

12. The system as set forth in claim 11, wherein said belt guides include a flat central portion for engaging said belts, and side portions for capturing and guiding said belts.

13. The system as set forth in claim 1, wherein said lance is a flexible lance.

14. A lance cleaning system comprising:
at least one lance for being connected to a source of high pressure fluid, and to a nozzle;
a drive mechanism for driving said lance;
wherein a housing for housing said drive mechanism includes two housing portions, and there being a latch to secure said housing portions together, and a hinge to attach said housing portions, such that said housing portions can pivot away from each other to provide access for changeover of said lance.

15. The system as set forth in claim 14, wherein said two housing portions include a vertically upper and vertically lower housing portion.

16. The system as set forth in claim 14, wherein said latch includes a member which can be positioned around a second portion, and said latch being selectively actuated to secure or release said housing portions from each other.

17. The system as set forth in claim 16, wherein a hinge is positioned on an opposed lateral side of said housing portions from said latch.

18. A lance cleaning system comprising:
at least one lance for being connected to a source of high pressure fluid, and to a nozzle;
a drive mechanism for driving said lance, said drive mechanism including at least one drive gear for engaging a belt, said belt engaging an outer periphery of said lance, and driving said lance; and
there being clamps which bias said drive belts against said lance.

19. The system as set forth in claim 18, wherein said clamps bias belt guides against said belts.

20. The system as set forth in claim 19, wherein said belt guides include a flat central portion for engaging said belt, and side portions for capturing and guiding said belt.
